(19) United States
(12) Patent Application Publication
(10) Pub. No.: US 2025/0008081 A1
(43) Pub. Date: Jan. 2, 2025

(54) CAMERA OPERATION VERIFICATION SYSTEM AND METHOD

(71) Applicant: Tyco Fire & Security GmbH, Neuhausen am Rheinfall (CH)

(72) Inventors: Brian C. RICHARD, Lunenburg, MA (US); Amit ROZNER, Yehud (IL); Yohay FALIK, Petah Tiqwa (IL); Calanit DOTAN, Neuhausen am Rheinfall (CH)

(21) Appl. No.: 18/757,458

(22) Filed: Jun. 27, 2024

Related U.S. Application Data
(60) Provisional application No. 63/523,552, filed on Jun. 27, 2023.

(51) Int. Cl. H04N 17/00; H04N 7/14; H04N 7/18; H04N 17/06

(52) U.S. Cl. CPC H04N 17/002; H04N 7/147; H04N 7/181; H04N 17/06

(57) ABSTRACT

A video camera recording system is provided. The aspects include one or more memories configured to store program code. The program code is for performing an automated verification test of elements of the video camera recording system using at least one artificial intelligence (AI) model to identify potential issues with the elements of the video camera recording system. The aspects further include one or more processors, operatively coupled to the one or more memories and configured to run the program code. The aspects also include a transceiver configured to transmit instructions causing a corrective action to be performed for at least one of the potential issues.

### PRIORITY

This application claims priority to provisional patent application Ser. No. 63/523,552, filed on Jun. 27, 2023, the disclosure of which is incorporated herein by reference.

### TECHNICAL FIELD

Aspects of the present disclosure relate generally to a camera operation verification system and method.

### BACKGROUND

In recent years, the field of surveillance has suffered from attacks against security systems becoming popular. For example, new generative Artificial Intelligence models (e.g., DeepFake) attacks pose a threat to security systems. In addition, security cameras are expensive to purchase and install. However, over the course of a year, a large percentage of deployed cameras become unusable due to camera movement, the camera being blocked, the presence of excessive darkness or brightness, blurring, and so forth.

Hence, there is a need to prevent physical or digital attacks and also to alert on camera quality degradation due to camera movement, blocked camera view, and so forth.

Moreover, another problem in the field of surveillance is that only after an incident occurs is it discovered that video of the incident is not available. This can be due to multiple reasons including, but not limited to, video camera issues (e.g., view obstructed, camera moved, water/blurry, malfunctioning camera, poor lighting at different hours of the day, etc.), network issues (the camera and/or recorder are offline), and/or video recorder issues (e.g., not recording video for that camera, recording was already overwritten (e.g., someone changed the recording settings from 90 days to 30), etc.).

To solve this problem today, high security sites routinely verify video operation by viewing each and every camera on site, and ensuring video is being recorded appropriately. However, this is a very slow and tedious process for larger sites with thousands of cameras. In addition, this becomes even greater of a challenge when the site uses video camera and/or video recorders from different manufacturers.

Hence, there is a need to verify the operation of each camera in an automatic manner and irrespective of the use of video recorders and/or video cameras made by different manufacturers.

In some monitored areas (e.g., buildings), operators may employ a monitoring system to detect different types of events occurring within and/or around the monitored area (e.g., unauthorized access to a room, a medical emergency, building fire, building flood). For example, an operator may install video cameras throughout a monitored area for monitoring the movement of people within the monitored area. In some instances, a video camera may malfunction, or be adjusted by an unauthorized party. However, in systems employing a large number of video cameras, it may be difficult and/or cumbersome to detect when a video camera is malfunctioning or adjusted.

Hence, there is a need for an automated way to determine when a video camera is malfunctioning or should be adjusted.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to aspects of the present disclosure, a video camera recording system is provided. The system includes one or more memories configured to store program code. The program code is for performing an automated verification test of elements of the video camera recording system using at least one artificial intelligence (AI) model to identify potential issues with the elements of the video camera recording system. The system further includes one or more processors, operatively coupled to the one or more memories and configured to run the program code. The system also includes a transceiver configured to transmit instructions causing a corrective action to be performed for at least one of the potential issues.

According to other aspects of the present disclosure, a method for video camera recording system operation verification is provided. The method includes performing an automated verification test of elements of the video camera recording system using at least one artificial intelligence (AI) model to identify potential issues with the elements of the video camera recording system. The method further includes transmitting instructions causing a corrective action to be performed for at least one of the potential issues.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 is a block diagram showing an example video camera recording system configured for automatic camera recording system operation verification, in accordance with an example aspect.

FIG. 2 is a block diagram showing another example video camera recording system configured for automatic camera recording system operation verification, in accordance with an example aspect.

FIG. 3 is a block diagram showing artificial intelligence models, in accordance with an example aspect.

FIG. 4 is a block diagram further showing artificial intelligence models, in accordance with an example aspect.

FIG. 5 is a flowchart of an example method for video camera recording system operation verification, in accordance with an example aspect.

FIG. 6 is a flowchart further showing the method of FIG. 5 for video camera recording system operation verification, in accordance with an example aspect.

FIG. 7, is a diagram showing an event monitoring system configured to monitor activity within and/or around a monitored area, and identify video capture device incidents, I accordance with an example aspect

FIG. 8 is a diagram showing an example of a monitoring interface, in accordance with an example aspect.

FIG. 9 is a flow diagram showing an example method for providing screen analysis for automated video camera inspection, in accordance with an example aspect.

FIG. 10 is a block diagram showing a computing device, in accordance with an example aspect.

### DETAILED DESCRIPTION

Aspects of the present disclosure are directed to a camera operation verification system and method.

The system is configured to perform real-time inspections for the following critical factors: sudden scene changes; blocked views; variations in lighting conditions; and AI DeepFake cyber-attack protection. Our automatic camera monitoring system offers capabilities in ensuring continuous, reliable surveillance across diverse environments. By proactively identifying and addressing issues, the system empowers operators with the tools needed to maintain optimal surveillance effectiveness and security.

Scene changes are detected through one of the following methods:
METHOD 1: Utilizing corresponding SIFT keypoints (kps) between the reference frame and the tested frame to identify movement. If a significant movement is detected, then a scene change alarm is triggered. However, METHOD 1 may not effectively detect complete scene changes or high differences in illumination between the frames.
METHOD 2: If METHOD 1 is ineffective due to complete scene changes or substantial differences in illumination, edges are identified in both frames. Template matching is then employed to determine the translation that provides the best match.

### Blocked View/Variations in Lighting Conditions

The detection of a blocked view involves identifying contours within the frame and examining the statistical properties of their grayscale levels.

Areas with significantly low/high grayscale values and low standard deviation are considered as potential blocked view regions or having lighting issues.

The first step involves detecting and delineating contours present within the frame.

These contours delineate the boundaries or outlines of various objects or features within the image, including instances of lighting issues or physical obstructions. Once the contours are identified, the next step is to analyze the grayscale levels associated with the pixels included within these contours. By examining the statistical properties of these grayscale levels, such as the mean and standard deviation, the characteristics of the areas delineated by the contours can be accessed. Regions characterized by notably low grayscale values and minimal variation (as indicated by low standard deviation) are indicative of areas where the view may be obstructed. Therefore, these regions are flagged as potential obstructed view areas, warranting further investigation or action in surveillance or monitoring applications.

This present disclosure leverages artificial intelligence (AI) to analyze the screen and automatically perform a verification test within the software (just like an operator would do). The AI is able to open and view each camera, detect if video appears, has been moved, distorted/blurry, ensure recorded video is available (to duration), etc., The system is able to do this automatically and efficiently on a random and adhoc schedule to ensure camera have vision across different weather, lighting conditions and also proactively tell camera has moved (real-time). As the cameras and recorders are inspected, a health dashboard can be displayed to advise where “cameras” are not functioning properly. The present disclosure works across most software, across most camera and recorder manufacturers; because the AI is able to learn to use the software like the operator uses the software to perform the same visual inspection.

This is the next generation of AI, that inspects and learns the software (via screen analysis), to perform the video verification and tests. No specific video hardware is required.

### Alternatives:

Some video manufacturers have some of this capability in their cameras and recorders or within their software, but this requires a specific hardware (HW) recorder, running specific firmware, and running specific camera HW. Many sites do not have the funding to do this. This software overlay does not require any special HW. In addition, this software (SW) works best when all of the cameras are being watched in a single Software instance like CCURE-IQ (and video integrations).

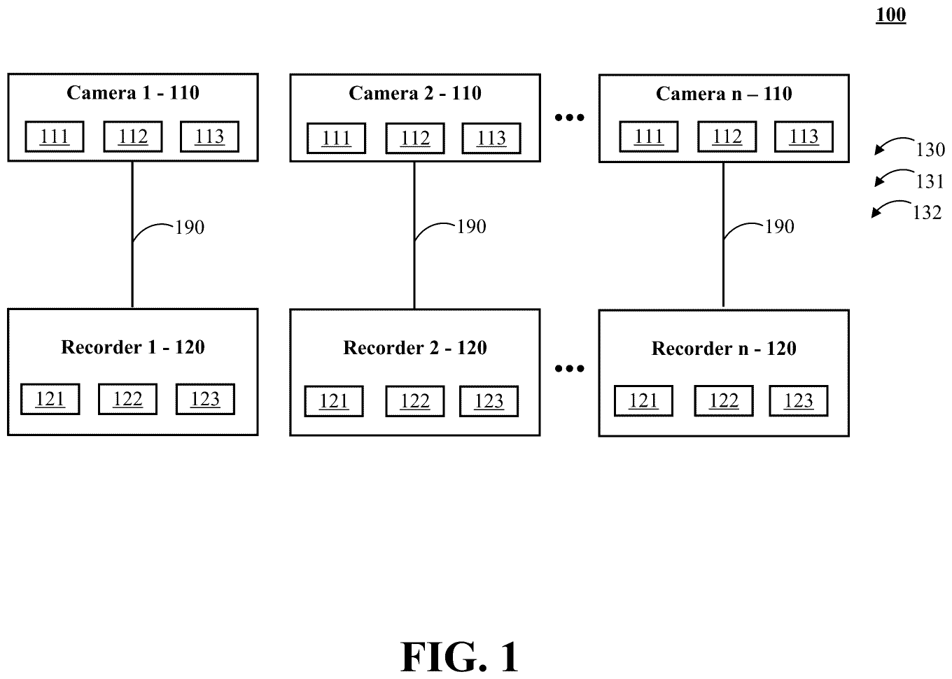

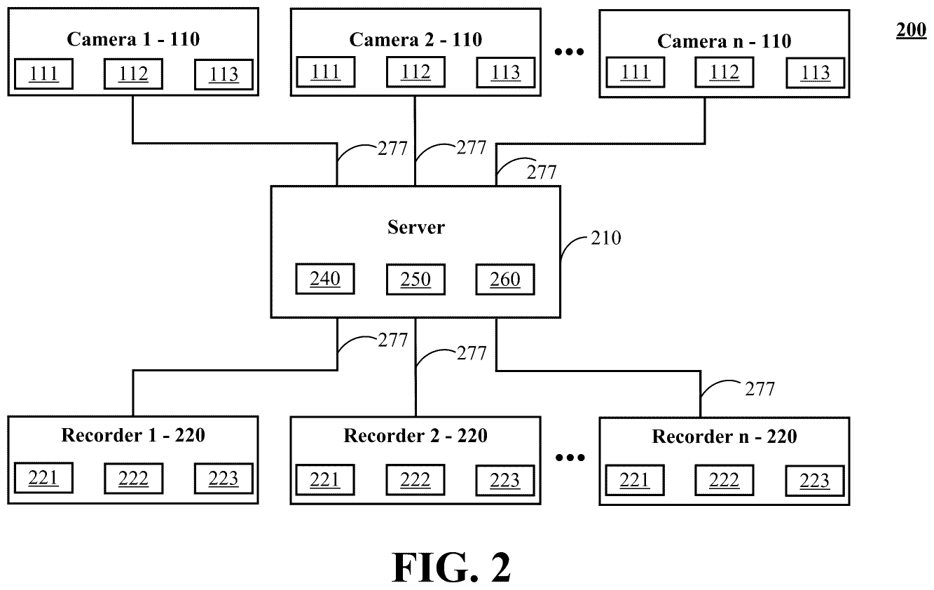

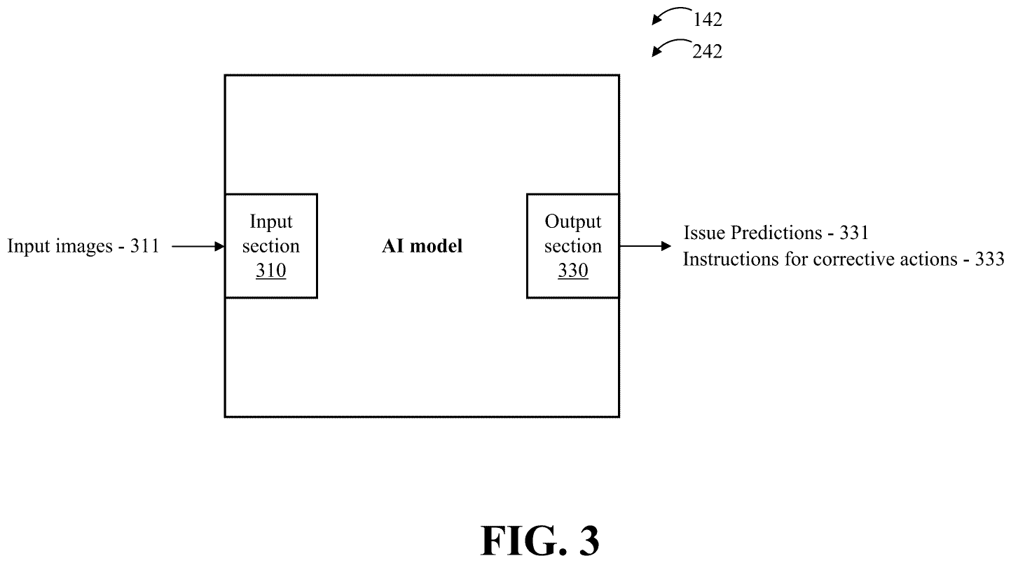

Referring to FIGS. 1-3, an example video camera recording system 100 configured for automatic camera recording system operation verification is shown in FIG. 1, another example video camera recording system 200 configured for automatic camera recording system operation verification is shown in FIG. 2, and AI models 142, 242 stored in memories of elements of the video camera recording system are shown in FIG. 3, in accordance with an example aspect.

The systems 100 and 200 include a set of video cameras 110 (e.g., cameras 1 to n) configured to capture video images, a set of video recorders 120 (e.g., recorders 1 to n) configured to record the captured video images, and a network 130 configured to connect the video cameras 110 to the video recorders 120.

In an aspect, the video cameras 110 include transceivers 113 and the video recorders 120 include transceivers 123 for communicating with each other over wireless network 131.

In an aspect, the video cameras 110 and the video recorders 120 are connected to each other via wire/cable 190 over wired network 132. While a 1 to 1 connection scheme is shown, any other connections of cameras to recorders can be used so that more than one camera may be assigned a particular recorder.

In the aspect of FIG. 1, the set of video cameras 110 include a set of one or more memories 111 and the set of video recorders 120 each include a set of one or more memories 121 configured to store program code as well as videos captured by the set of video cameras 110. The set of video cameras 110 include a set of one of one or more processors 112 and the set of video recorder 120 include a set of one or more processors 122 configured to run the program code. The program code is for automatic camera recording system operation verification using artificial intelligence based issue detection. In an aspect, each video camera 110 and/or each video recorder 120 may include a set of memories 111, 121 and a set of processors 112, 122.

In the aspect of FIG. 2, system 200 includes a server 210 having a set of one or more memories 240 configured to store program code and a set of one or more processors 250 configured to run the program code. In an aspect, each video camera and video recorder pair (there can be overlap, but a pair refers to the video camera and the video recorder assigned to the video camera) includes a respective set of one or more memories 240 and respective set of one or more processors 250. The program code is for automatic camera recording system operation verification using artificial intelligence based issue detection. In an aspect, a wireless transceiver 260 is configured to communicate with the wireless transceivers 113, 223 of the video cameras and the video recorders, respectively. In an aspect, wires 277 are used to interconnect the system elements.

The sets of one or more memories 111, 121, 240 and the sets of one or more processors 122, 222, 250 cooperate to store and execute program code for automatic video camera recording system operation verification using artificial intelligence based issue detection. To that end, the sets of one or more memories 111, 121, 240 further store AI models 142, 242 for identifying video camera issues, video recorder issues, and/or network issues. The sets of one or more memories 111, 121, 240 further store videos captured by the set of cameras 110.

The AI models 142, 242 are configured to receive image frames as input for comparison to reference frames corresponding to particular issues from among video camera issues, video recorder issues, and network issues. The AI models 142, 242 may repeatedly, at predetermined times, go through training to learn to identify various issues by reducing an error between an input image and a reference image selected as best corresponding to the input image. For example, a blocked camera may be depicted in an input image and similarly in a reference image. Hence, for all but the same predictions of, for example, a percentage of being blocked, there will be an error value. The closer the predicted reference image to the input image, the less the error therebetween.

Each of the AI models 142, 242 include an input section 310 configured to pre-process (scale, rotate, and so forth) input images 311 in preparation for comparison to reference images 321 stored in a reference section 320.

The comparison between input images and reference images can be scene-wise, object-wise, pixel-wise, and so forth. Any level of granularity can be used, depending upon the implementation versus the speed of result to be provided by the system, with the higher the granularity the slower the system result.

Outputs from an output section 330 of the AI models 142, 242 provide a prediction 331 of a possible (camera, recorder, and/or network) issue being encountered. Issue predictions are pre-mapped to the reference images they correspond to. In this way, upon detecting a match between an input image and a reference image (based on having the lowest error or difference there between), metadata associated with the reference image such as an implicated issue can be determined, where implicated issues can be from among video camera issues, video recorder issues, and/or network issues.

In an aspect, the prediction 331 may be provided with a confidence value 332. In an aspect, the confidence value 332 may be based on the error so that the larger the confidence value 332, the smaller the error between an input image and a reference image.

In an aspect, outputs from output section 330 may include instructions 333 for corrective actions to be initiated such as holding the camera still and/or resetting its position, cleaning the lens using a self-cleaning operation, re-focusing to overcome blurriness, replacing a broken camera, broken recorder, and/or broken network element, and so forth. A multiplexer may be connected to form pools of camera, recorders, and network elements from which cameras, recorders, and network elements are selected and readily swapped out when damage is detected. In this way, detection of an issue can be achieved as well as correction of the issue.

As one basis for error, each different pixel between an input image and a reference image may result in one or a preset number of error points being added to the final error score. Other basis may be used.

As a basis for error in a video camera, camera movement (oscillating pixel values indicative of camera movement and/or vibration), camera field of view blockage (blocked pixels), blurriness (out of focus), moisture (drop shaped obstructions), and so forth may be detected and indicated as a video camera issue.

As a basis for error in a video recorder and/or a network, any corruption of the recorded signal relative to the originally captured signal such as different pixel values or missing pixel values may be detected and indicated as a video recording issue. Also, a lack of meeting a specified video duration may be indicative of a recorder issue (e.g., lack of space/memory, and so forth).

As a basis for error in a network, an inability to transmit or receive an otherwise uncorrupted signal may be detected and indicated as a network issue. For example, a signal may be CRC checked at a transmitter and unable to be received by a receiver, indicating a network issue such as insufficient power at the transmitter for transmission, problems with the communication channel (broken wire/cable or blocked wireless transmission), or problems with the receiver (antenna issues, etc.).

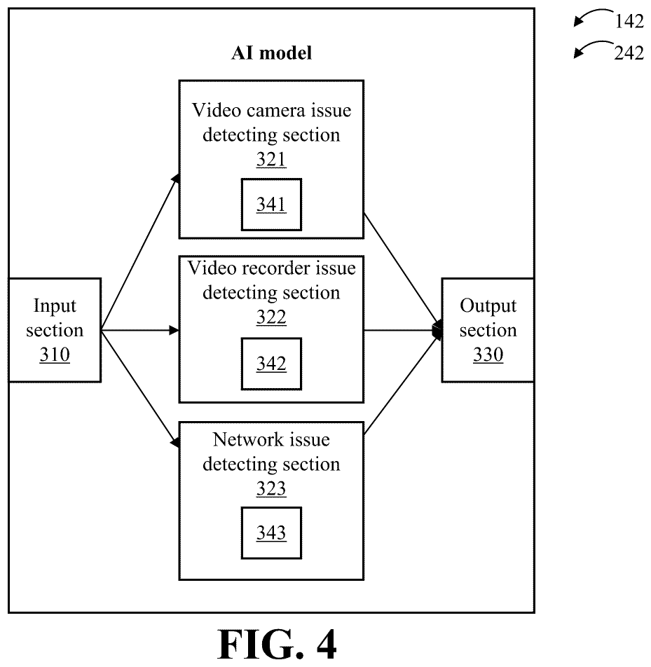

Referring to FIG. 4, AI models 142, 242 are further shown, in accordance with an example aspect.

AI models 142, 242 include, in addition to the aforementioned input section 310 and output section 330, separate sections for detecting video camera issues, video recorder issues, and network issues, namely a video camera issue detecting section 321, a video recorder issue detecting section 322, and a network issue detecting section 323, respectively.

Each section from among sections 321-323 include a respective corresponding reference image database for use in comparing to input images. For example, the video camera issue detecting section 321 includes a video camera issue detecting database 341, the video recorder issue detecting section 322 includes a video recorder issue detecting database 342, and the network issue detecting section 323 includes a network issue detecting database 343. Each of the sections 321-323 compares the input images to the corresponding database 341-343, respectively, so as to identify a particular issue 331 in a particular domain (e.g., camera, recorder, network) and provide instructions 333 for corrective action of the issue(s).

The output section 330 may implement max pooling or other functions on the domain outputs such as the domain specific issues 331 and corresponding instructions 333 for corrective action to arrive at a prediction result which may include more than one issue being specified and more than one corrective action being also specified and ultimately performed.

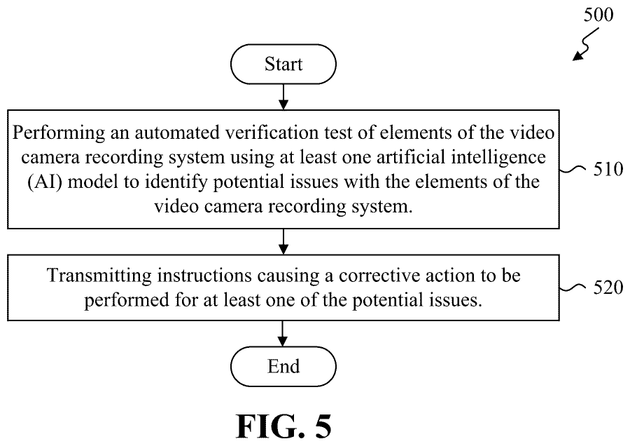

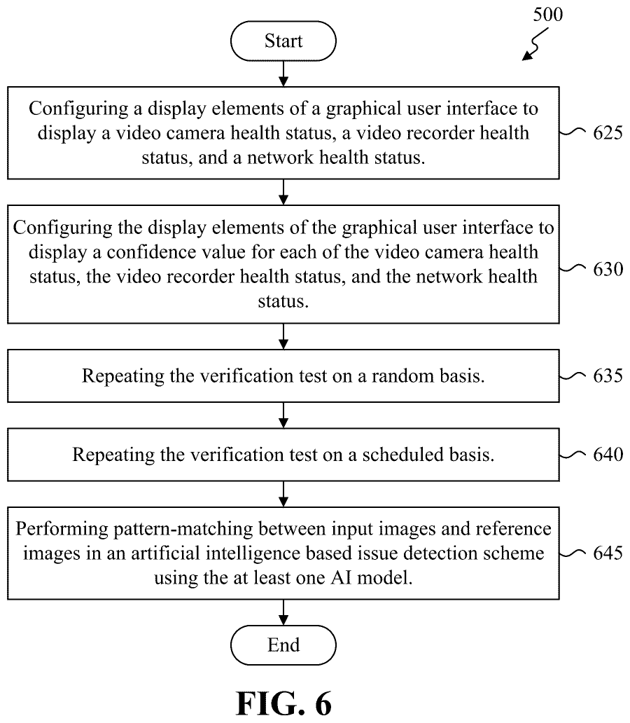

Referring now to FIGS. 5-6, a method 500 for automatic video camera recording system operation verification using artificial intelligence is shown and described in accordance with various example aspects. Boxes shown in dashes are optional features.

Method 500 may be performed by at least in part performed by one or more processors (e.g., one or more processors 111, 121 of FIG. 1 and one or more processors 150 of FIG. 2) operatively coupled to one or more memories (e.g., one or more memories 112, 122 of FIG. 1 and one or more memories 140 of FIG. 2).

FIG. 5 is a flowchart of an example method 500 for video camera recording system operation verification, in accordance with an example aspect.

At block 510, method 500 includes performing an automated verification test of elements of the video camera recording system using at least one artificial intelligence (AI) model to identify potential issues with the elements of the video camera recording system.

At block 520, method 500 includes transmitting instructions causing a corrective action to be performed for at least one of the potential issues. For example, in an aspect, the method 500 may be performed on board camera and/or recorder and/or network card for self-correction by the entity running the method. In another aspect, the server 200 may transmit instructions for corrective action to a camera, recorder, and/or network element such as a network card to perform a self-corrective action or control another system element (motor, lens, shutter, etc.) to perform a correction action.

FIG. 6 is a flowchart further showing the method 500 of FIG. 5 for video camera recording system operation verification, in accordance with an example aspect.

Blocks 625 and 630 describe the use of a graphical user interface to display system component health status and a confidence value for the system component health status. In this way, in addition to providing instructions in block 520 to an entity that can correct the issue, the system graphically provides a way to gauge the health of various system components such as video cameras, video recorders, and network elements.

At block 625, the method 500 includes configuring a display elements of a graphical user interface to display a video camera health status, a video recorder health status, and a network health status. For example, a first widget (graph, number range, color, etc.) may display video camera health status, a second widget may display a video recorder health status, and a third widget may display a network health status.

At block 630, the method 500 includes configuring the display elements of the graphical user interface to display a confidence value for each of the video camera health status, the video recorder health status, and the network health status.

Blocks 635 and 640 describe two ways to repeat the verification test of block 505.

At block 635, the method 500 includes repeating the verification test on a random basis.

At block 640, the method 500 includes repeating the verification test on a scheduled basis.

Block 645 further describes the verification test of block 505.

At block 645, the method 500 includes performing pattern-matching between input images and reference images in an artificial intelligence based issue detection scheme using the at least one AI model.

Further to the description above relating to comparing input images captured by a camera to reference images relating to artificial intelligence models to detect image difference, implementations of the present disclosure provide screen analysis for automated video camera inspection. In some implementations, one problem solved by the present disclosure is camera inspection in heterogeneous environments, which can be difficult to solve with other approaches. For example, this present disclosure describes systems and methods that employ computer vision in image comparisons to perform camera and other video camera recoding system component inspection and detect malfunction and/or unauthorized modification to a video camera, and/or a video recorder and/or a network element, which provides efficiency and case of implementation benefits over approaches that require manual inspection, development of components for inspecting video information output by different types of video cameras, or decryption of video information output by a video camera.

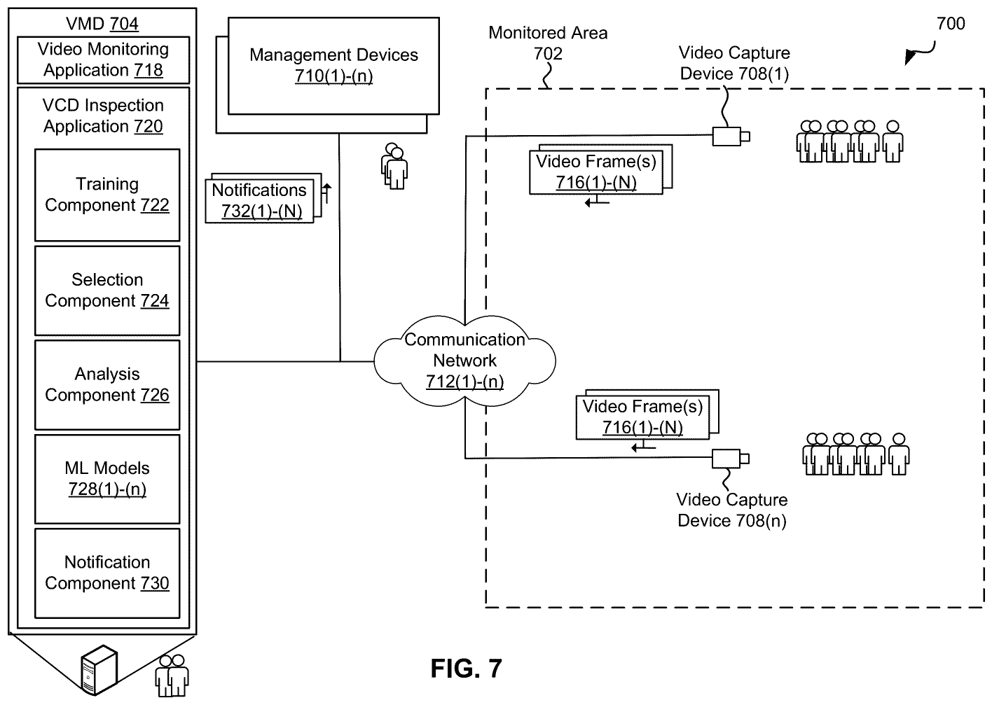

Referring to FIG. 7, in one non-limiting aspect, an event monitoring system 700 is configured to monitor activity within and/or around a monitored area 702, and identify video capture device incidents. For example, event monitoring system 700 is configured to capture video feed data, and analyze the video feed data as displayed on a display device to detect video capture device incidents. Event monitoring system 700 is a system in which the present disclosure would be deployed to detect camera, recorder, and/or network issues. Aspects of the present disclosure may be applied to systems having hundreds or even thousands of cameras, where it is infeasible to manually check the operation of each camera and its corresponding recorder(s). Accordingly, aspects of the present disclosure advantageously permit for automatic camera recording system operation verification using artificial intelligence to learn as time goes on so as to improve the system accuracy in predicting issues such as component issues and which components. To that end, the aforementioned instructions for corrective action may identify which components to automatically replace using, for example, the aforementioned multiplexer and/or a relay system and/or so forth.

As illustrated in FIG. 7, the event monitoring system 700 may include a video monitoring device (VMD) 704, one or more video capture devices 708(1)-(n) (e.g., a video camera), one or more management devices 710(1)-(n), and/or one or more communication networks 712(1)-(n). Further, the one or more video capture device 708(1)-(n) may be positioned in different areas of the monitored area 702. In some implementations, a communication network 712 may include a plain old telephone system (POTS), a radio network, a cellular network, an electrical power line communication system, one or more of a wired and/or wireless private network, personal area network, local area network, wide area network, and/or the Internet. Further, in some aspects, the video monitoring device 704, the one or more video capture devices 708(1)-(n), and the one or more management devices 710(1)-(n) may be configured to communicate via the communication networks 712(1)-(n).

In some aspects, the video capture devices 708(1)-(n) may capture one or more video frames 716(1)-(n) of activity within the monitored area 702, and transmit the one or more video frames 116(1)-(n) to the video monitoring device 704 via the communications network 712(1)-(n). Some examples of the management devices 710(1)-(n) include smartphones, computing devices, Internet of Things (IoT) devices, video game systems, robots, process automation equipment, control devices, vehicles, transportation equipment, and virtual and augmented reality (VR and AR) devices.

The video monitoring device 704 may be configured to receive the one or more video frames 716(1)-(n) from the video capture devices 708(1)-(n), present a monitoring interface (e.g., a graphical user interface) for viewing of the one or more video frames 716(1)-(n), inspect the video capture devices 708(1)-(n) based at least in part on the one or more video frames 716(1)-(n), and generate notifications upon detection of a video capture device incident at a video capture device 708 based on the inspection. As illustrated in FIG. 7, the video monitoring device 704 may include a video monitoring application 718 for presenting a monitoring interface for viewing the one or more video frames 716(1)-(n). In some aspects, the video monitoring application 718 may present a live stream including the one or more frames 716 or present playback of previously-captured video frames 716(1)-(n). For example, security personnel may monitor activity within the monitored area 702 by viewing the one or more frames 716 as presented by the video monitoring application 718. In some examples, the monitoring interface may provide playback controls for managing the viewing experience. Some examples of playback controls include magnifying/shrinking the one or more frames 716, speed up/down playback of the one or more frames 716, increase/decrease volume, fast-forward or rewind playback of the one or more frames 716, or play/pause/end playback of the one or more frames 716.

Further, the video monitoring device 704 may include a VCD inspection application 720 for inspecting the video capture devices 708(1)-(n) based at least in part on the one or more video frames 716(1)-(n), and generating notifications upon detection of a video capture device incident at a video capture device 108 based on the inspection. As illustrated herein, in some aspects, the VCD inspection application 720 may include a training component 722, a selection component 724, an analysis component 726, one or more ML models 728(1)-(n), and a notification component 730.

In some aspects, the training component 722 may train the one or more ML models 728(1)-(n) to identify function incidents at a video capture device 708 based on analysis of a video capture feed of a video capture device 708. For example, the training component 722 may train the one or more ML models 728(1)-(n) based on historic video information (e.g., previously-captured video frames 716(1)-(n)). In some aspects, a “function incident” may refer to a malfunction, offline status, and/or modification to a positioning, field of view, or other capture attribute of a video capture device. For example, in some aspects, the training component 722 may train the one or more ML models 728(1)-(n) to identify blur, a screen having a predefined color output e.g., black, blue, white, etc.), noise, an offline status, display of incorrect date and time information, an interrupted feed, an adjustment to a field of view of the video capture device, and/or an absence of liveliness (to detect a DeepFake). In addition, the training component 722 may train the one or more ML models 728(1)-(n) to determine whether a camera is obstructed or partially obstructed. In some examples, the one or more ML models 728 may include a neural network, deep learning network, convolutional neural network, and/or any another type of machine learning model. In some aspects, a “neural network” may refer to a mathematical structure taking an object as input and producing another object as output through a set of linear and non-linear operations called layers. Such structures may have parameters which may be tuned through a learning phase to produce a particular output, for instance, a function incident determination.

Further to detecting a DeepFake, in the case of a video sequence of a parking lot consisting of parking spaces and no trees or shrubs, the presence of a tree in the middle of the parking lot in a particular frame would be considered a fake by the system and an alert would then be provided to the proper authorities as well as the capturing of relevant electronic data including Internet Protocol address and so forth.

In some aspects, the selection component 724 selects a video capture feed of a video capture device for analysis by the VCD inspection application 720. In some aspects, the selection component 724 receives selection of a video capture device 708 and/or a video frames 716 received from a video capture device 708 via a graphical user interface (GUI) from a user. In some other aspects, the selection component 724 automatically selects a video capture feed of a video capture device 108 for analysis by the VCD inspection application 720. For example, the selection component 724 may periodically select each of the video capture devices 708 for inspection by the VCD inspection application 720. Further, in some aspects, the selection component 724 determines the area where the monitoring interface displays the one or more video frames 716(1)-(n). For example, the selection component 724 may identify the area of a display device where the monitoring interface displays the one or more video frames 716(1)-(n). In some aspects, the one or more ML models may be further configured to identify an area of display of the one or more frames 716(1)-(n) on the display device.

In some aspects, the analysis component 726 determines whether there is a function incident within one or more video frames 716 of a video capture device 708 selected by the selection component 724. In some aspects, the analysis component 726 employs the one or more ML models 728(1)-(n) to identify function incidents. In particular, the analysis component 726 may capture one or more video frames 716 displayed by the monitoring interface (e.g., the analysis component 726 may capture the one or more video frames 716 at an area determined by the selection component 124), provide the captured one or more video frames 716 to the one or more ML models 728(1)-(n), and determine the occurrence of a function incident based upon the output of the one or more ML models 728(1)-(n). In some aspects, the one or more ML models 728 determine one or more attribute of the captured video frames 716, compare the one or more attributes to reference information to generate one or more function incident scores, and identifies a function incident based at least in part on a function incident score being greater than predefined threshold. In some examples, each function incident score corresponds to a different type of function incident.

The notification component 730 may be configured to present GUIs including a notification 732 identifying an occurrence of a function incident and/or send notifications 730(1)-(n) identifying an occurrence of a function incident to the management devices 710(1)-(n). Further, in some aspects, the notifications may be transmitted in response to a function incident identified by the analysis component 726. In some instances, the notifications 130(1)-(n) may be one or more of a visual notification, audible notification, or electronic communication (e.g., text message, email, etc.) to the management devices 710(1)-(n). Further, a notification 732 may be presented and/or sent to a user responsible for the video capture device 708 associated with the function incident.

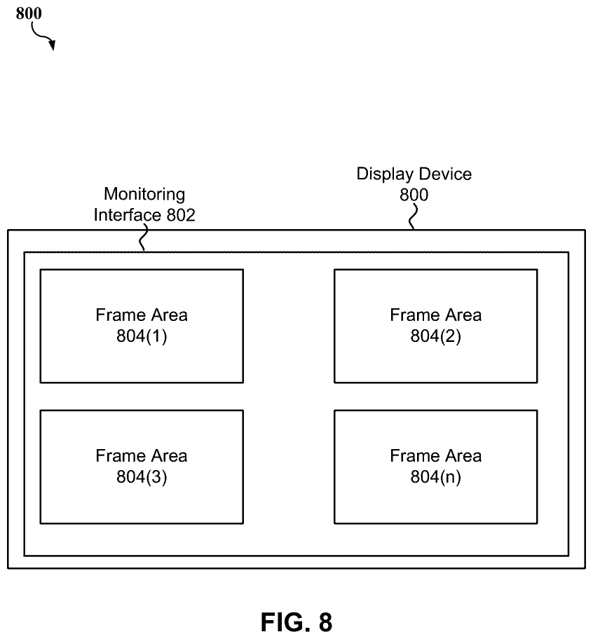

FIG. 8 is an example 800 of a monitoring interface 802, according to some implementations.

As described in detail herein, the monitoring interface 802 displays individual frame areas 804 for video capture devices (e.g., video capture device 708). For example, the monitoring interface 802 presents a first frame area 804(1) that displays a plurality of video frames received from a first video capture device, a second frame area 804(1) that displays a plurality of video frames received from a second video capture device, a third frame area 804(3) that displays a plurality of video frames received from a third video capture device, and a nth frame area 804(n) that displays a plurality of video frames received from a nth video capture device. Further, as described herein, one or more frame areas 804 may be selected for inspection by the analysis component 726. Upon selection, the one or more video frames displayed within a selected frame area 804 is analyzed by the analysis component 726.

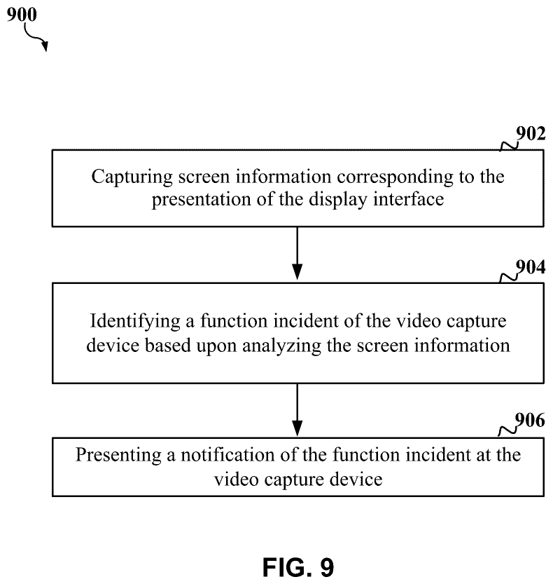

Referring to FIG. 9, in operation, the video monitoring device 704 or computing device 1000 may perform an example method 900 for providing screen analysis for automated video camera inspection. The method 900 may be performed by one or more components of the video monitoring device 704, the computing device 1000, or any device/component described herein according to the techniques described with reference to FIGS. 7-8.

At block 902, the method 900 includes capturing screen information corresponding to video presentation on a display interface. For example, the video capture devices 708(1)-(n) may capture the one or more video frames 716(1)-(n) and transmit the one or more video frames to the video monitoring device 704. Further, the selection component 724 may select a video capture device 708 and determine an area of display of the one or more frames 716 of the video capture device within a monitoring interface of a video monitoring application 718. In addition, the analysis component 726 may capture the one or more frames 716 of the selected video capture device 708. In some aspects, the analysis component 726 includes screen capture functionalities for capturing the one or more video frames 716 during display via a display device of the video monitoring device 704. Accordingly, the video monitoring device 704, the computing device 1000, and/or the processor 1002 executing the selection component 724 and the analysis component 726 may provide means for capturing screen information corresponding to video presentation on a display interface.

At block 904, the method 900 includes identifying a function incident of the video capture device based upon analyzing the screen information. For example, the analysis component 726 may identify a function incident within the captured one or more frames 716 of the video capture device 708 via the one or more ML models 728(1)-(n). Accordingly, the video monitoring device 704, the computing device 1000, and/or the processor 1002 executing the analysis component 726 may provide means for identifying a function incident of the video capture device based upon analyzing the screen information.

At block 906, the method 900 includes presenting a notification of the function incident at the video capture device. For example, if a function incident is identified, the notification component 730 may present a graphical user interface (GUI) including a notification 732 corresponding to detection of a function incident at the selected video capture device 708. Accordingly, the video monitoring device 704, the computing device 1000, and/or the processor 1002 executing the notification component 730 may provide means for presenting a notification of the function incident at the video capture device.

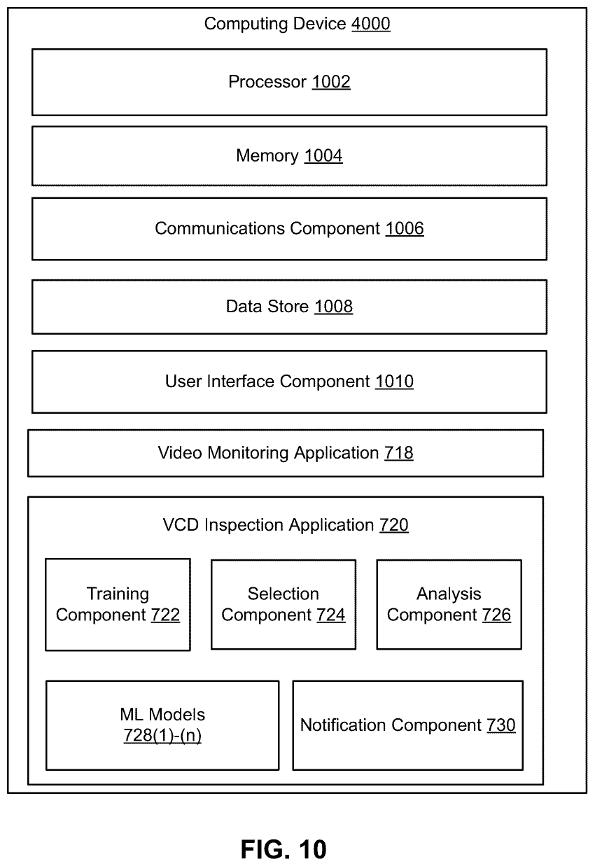

Referring to FIG. 10, a computing device 1000 may implement all or a portion of the functionality described herein. The computing device 1000 may be or may include or may be configured to implement the functionality of at least a portion of the event monitoring system 700, or any component therein. For example, the computing device 1000 may be or may include or may be configured to implement the VCD inspection application 720, the training component 722, the selection component 724, the analysis component 726, the one or more ML models 728(1)-(n), and the notification component 730. The computing device 1000 includes a processor 1002 which may be configured to execute or implement software, hardware, and/or firmware modules that perform any functionality described herein. For example, the processor 1002 may be configured to execute or implement software, hardware, and/or firmware modules that perform any functionality described herein with reference to the VCD inspection application 720, the training component 722, the selection component 724, the analysis component 726, the one or more ML models 728(1)-(n), the notification component 730, or any other component/system/device described herein. The processor 1002 may be a micro-controller, an application-specific integrated circuit (ASIC), a digital signal processor (DSP), or a field-programmable gate array (FPGA), and/or may include a single or multiple set of processors or multi-core processors. Moreover, the processor 1002 may be implemented as an integrated processing system and/or a distributed processing system. The computing device 1000 may further include a memory 1004, such as for storing local versions of applications being executed by the processor 1002, related instructions, parameters, etc. The memory 1004 may include a type of memory usable by a computer, such as random access memory (RAM), read only memory (ROM), tapes, magnetic discs, optical discs, volatile memory, non-volatile memory, and any combination thereof. Additionally, the processor 1002 and the memory 1004 may include and execute an operating system executing on the processor 1002, one or more applications, display drivers, etc., and/or other components of the computing device 1000.

Further, the computing device 1000 may include a communications component 1006 that provides for establishing and maintaining communications with one or more other devices, parties, entities, etc. utilizing hardware, software, and services. The communications component 1006 may carry communications between components on the computing device 1000, as well as between the computing device 1000 and external devices, such as devices located across a communications network and/or devices serially or locally connected to the computing device 1000. In an aspect, for example, the communications component 1006 may include one or more buses, and may further include transmit chain components and receive chain components associated with a wireless or wired transmitter and receiver, respectively, operable for interfacing with external devices.

Additionally, the computing device 1000 may include a data store 1008, which can be any suitable combination of hardware and/or software, that provides for mass storage of information, databases, and programs. For example, the data store 1008 may be or may include a data repository for applications and/or related parameters not currently being executed by processor 1002. In addition, the data store 1008 may be a data repository for an operating system, application, display driver, etc., executing on the processor 1002, and/or one or more other components of the computing device 1000.

The computing device 1000 may also include a user interface component 1010 operable to receive inputs from a user of the computing device 1000 and further operable to generate outputs for presentation to the user (e.g., via a display interface to a display device). The user interface component 1010 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 1010 may include one or more output devices, including but not limited to a display interface, a speaker, a haptic feedback mechanism, a printer, any other mechanism capable of presenting an output to a user, or any combination thereof.

Additional aspects of the present disclosure may include one or more of the following clauses.

Clause 1. A video camera recording system, comprising: one or more memories configured to store program code, wherein the program code is for performing an automated verification test of elements of the video camera recording system using at least one artificial intelligence (AI) model to identify potential issues with the elements of the video camera recording system; one or more processors, operatively coupled to the one or more memories and configured to run the program code; and a transceiver configured to transmit instructions causing a corrective action to be performed for at least one of the potential issues.

Clause 2. The video camera recording system in accordance with clause 1, wherein the elements of the video camera recording system subjected to the automated verification test comprise video cameras, video recorders, and networks connecting the video cameras to the video recorders.

Clause 3. The video camera recording system in accordance with any preceding clauses, wherein the potential issues comprise video camera issues, video recorder issues, and network issues.

Clause 4. The video camera recording system in accordance with any preceding clauses, wherein the video camera issues comprise unintended camera movement, distortion, and blurriness.

Clause 5. The video camera recording system in accordance with any preceding clauses, wherein the video recording issues comprise an incorrect video duration.

Clause 6. The video camera recording system in accordance with any preceding clauses, further comprising a graphical user interface having display elements configured to display a video camera health status, a video recorder health status, and a network health status.

Clause 7. The video camera recording system in accordance with any preceding clauses, wherein the graphical user interface further has display elements configured to display a confidence value for each of the video camera health status, the video recorder health status, and the network health status.

Clause 8. The video camera recording system in accordance with any preceding clauses, wherein the verification test is repeated on a random basis.

Clause 9. The video camera recording system in accordance with any preceding clauses, wherein the verification test is repeated on a scheduled basis.

Clause 10. The video camera recording system in accordance with any preceding clauses, wherein the artificial intelligence comprises pattern-matching between input images and reference images.

Clause 11. A method for video camera recording system operation verification, comprising: performing an automated verification test of elements of the video camera recording system using at least one artificial intelligence (AI) model to identify potential issues with the elements of the video camera recording system; and transmitting instructions causing a corrective action to be performed for at least one of the potential issues.

Clause 12. The method in accordance with clause 11, wherein the elements of the video camera recording system subjected to the automated verification test comprise video cameras, video recorders, and networks connecting the video cameras to the video recorders.

Clause 13. The method in accordance with any preceding clauses, wherein the potential issues comprise video camera issues, video recorder issues, and network issues.

Clause 14. The method in accordance with any preceding clauses, wherein the video camera issues comprise unintended camera movement, distortion, and blurriness.

Clause 15. The method in accordance with any preceding clauses, wherein the video recording issues comprise an incorrect video duration.

Clause 16. The method in accordance with any preceding clauses, further comprising configuring a display elements of a graphical user interface to display a video camera health status, a video recorder health status, and a network health status.

Clause 17. The method in accordance with any preceding clauses, further configuring the display elements of the graphical user interface to display a confidence value for each of the video camera health status, the video recorder health status, and the network health status.

Clause 18. The method in accordance with any preceding clauses, wherein the verification test is repeated on a random basis.

Clause 19. The method in accordance with any preceding clauses, wherein the verification test is repeated on a scheduled basis.

Clause 20. The method in accordance with any preceding clauses, wherein the artificial intelligence comprises pattern-matching between input images and reference images.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A video camera recording system, comprising:
one or more memories configured to store program code, wherein the program code is for performing an automated verification test of elements of the video camera recording system using at least one artificial intelligence (AI) model to identify potential issues with the elements of the video camera recording system;
one or more processors, operatively coupled to the one or more memories and configured to run the program code; and
a transceiver configured to transmit instructions causing a corrective action to be performed for at least one of the potential issues.

2. The video camera recording system in accordance with claim 1, wherein the elements of the video camera recording system subjected to the automated verification test comprise video cameras, video recorders, and networks connecting the video cameras to the video recorders.

3. The video camera recording system in accordance with claim 2, wherein the potential issues comprise video camera issues, video recorder issues, and network issues.

4. The video camera recording system in accordance with claim 3, wherein the video camera issues comprise unintended camera movement, distortion, and blurriness.

5. The video camera recording system in accordance with claim 3, wherein the video recording issues comprise an incorrect video duration.

6. The video camera recording system in accordance with claim 1, further comprising a graphical user interface having display elements configured to display a video camera health status, a video recorder health status, and a network health status.

7. The video camera recording system in accordance with claim 6, wherein the graphical user interface further has display elements configured to display a confidence value for each of the video camera health status, the video recorder health status, and the network health status.

8. The video camera recording system in accordance with claim 1, wherein the verification test is repeated on a random basis.

9. The video camera recording system in accordance with claim 1, wherein the verification test is repeated on a scheduled basis.

10. The video camera recording system in accordance with claim 1, wherein the artificial intelligence comprises pattern-matching between input images and reference images.

11. A method for video camera recording system operation verification, comprising:
performing an automated verification test of elements of the video camera recording system using at least one artificial intelligence (AI) model to identify potential issues with the elements of the video camera recording system; and
transmitting instructions causing a corrective action to be performed for at least one of the potential issues.

12. The method in accordance with claim 11, wherein the elements of the video camera recording system subjected to the automated verification test comprise video cameras, video recorders, and networks connecting the video cameras to the video recorders.

13. The method in accordance with claim 12, wherein the potential issues comprise video camera issues, video recorder issues, and network issues.

14. The method in accordance with claim 13, wherein the video camera issues comprise unintended camera movement, distortion, and blurriness.

15. The method in accordance with claim 13, wherein the video recording issues comprise an incorrect video duration.

16. The method in accordance with claim 11, further comprising configuring a display elements of a graphical user interface to display a video camera health status, a video recorder health status, and a network health status.

17. The method in accordance with claim 16, further configuring the display elements of the graphical user interface to display a confidence value for each of the video camera health status, the video recorder health status, and the network health status.

18. The method in accordance with claim 11, wherein the verification test is repeated on a random basis.

19. The method in accordance with claim 11, wherein the verification test is repeated on a scheduled basis.

20. The method in accordance with claim 11, wherein the artificial intelligence comprises pattern-matching between input images and reference images.
